(19) United States
(12) Patent Application Publication
(10) Pub. No.: US 2014/0317564 A1
(43) Pub. Date: Oct. 23, 2014

(54) NAVIGATION AND LANGUAGE INPUT USING MULTI-FUNCTION KEY

(71) Applicant: SYNAPTICS INCORPORATED, San Jose, CA (US)

(72) Inventors: Daniel L. ODELL, Sunnyvale, CA (US); Jerry SHAO, San Jose, CA (US); Mohamed Ashraf Sheik-Nainar, San Jose, CA (US)

(21) Appl. No.: 14/013,322

(22) Filed: Aug. 29, 2013

Related U.S. Application Data
(60) Provisional application No. 61/814,980, filed on Apr. 23, 2013.

(51) Int. Cl. G06F 3/0482

(52) U.S. Cl. CPC G06F 3/0482
USPC 715/810

(57) ABSTRACT

Methods and apparatus for menu navigation and selection are described. The apparatus comprises a keyboard having a plurality of keys for a user to enter information by interacting with one or more of the plurality of keys, and a multi-function key having a touch sensitive portion for the user to enter position information by a touch or gesture input or enter information via user interaction with the multi-function key. A processing system is coupled to the keyboard for processing the user entered information and user entered position information from the keyboard and a display coupled to the processing system for displaying the user entered information and a menu of options related to the user entered information. The user enters position information to navigate through the menu of options and selects an option from the menu of options by user entered interaction with the multi-function key.

### RELATED APPLICATION

This application claims the benefit of U.S. Provisional Application No. 61/814,980 filed Apr. 23, 2013.

### TECHNICAL FIELD

This invention generally relates to electronic devices.

### BACKGROUND

Input Method Editors (IMEs) in Japanese (e.g., via romanji) and Chinese (e.g., via pinyin) and other languages make frequent use of user menu selections to disambiguate possible character combinations based on phonetic input. For some entries, this disambiguation can occur for every character or short phrase, which can greatly slow down input or frustrate users. For example, existing approaches present menus that are selected by pressing the number associated with the menu item or through the use of arrow keys.

Input devices including proximity sensor devices (e.g., touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems such as opaque touchpads either integrated in, or peripheral to, notebook or desktop computers. Proximity sensor devices are also often used in smaller computing systems such as touch screens integrated in cellular phones.

### BRIEF SUMMARY OF THE INVENTION

Methods and apparatus for menu navigation and selection are described. The apparatus comprises a keyboard having a plurality of keys for a user to enter information by interacting with one or more of the plurality of keys, and a multi-function key having a touch sensitive portion for the user to enter position information by a touch or gesture input or enter information via user interaction with the multi-function key. A processing system is coupled to the keyboard for processing the user entered information and user entered position information from the keyboard and a display coupled to the processing system for displaying the user entered information and a menu of options related to the user entered information. The user enters position information to navigate through the menu of options and selects an option from the menu of options by user entered interaction with the multi-function key.

The method comprises receiving information input from one or more of the plurality of keys and displaying a menu of options related to the received information on a display. The user navigates through the menu of options by entered position information received from the touch sensitive portion of the multi-function key. Thereafter, the user selects an option from the menu of options via a user entered interaction with the multi-function key.

### BRIEF DESCRIPTION OF DRAWINGS

Example embodiments of the present invention will hereinafter be described in conjunction with the appended drawings which are not to scale unless otherwise noted, where like designations denote like elements, and:

FIG. 1 illustrates an exemplary input system that incorporates one or more implementations of a navigation and input system in accordance with various embodiments;

FIGS. 2A-C illustrate an exemplary navigation and input selection in accordance with various embodiments;

FIGS. 3A-B illustrate an alternative navigation and input selection in accordance with various embodiments;

FIGS. 4A-B illustrate an exemplary navigation and input selection for multiple touch interaction in accordance with various embodiments;

FIGS. 5A-C illustrate exemplary menu configurations in accordance with various embodiments; and

FIG. 6 is a flow diagram of an exemplary method in accordance with various embodiments.

### DETAILED DESCRIPTION OF THE INVENTION

Example embodiments of the present invention will hereinafter be described in conjunction with the drawings which are not to scale unless otherwise noted and where like designations denote like elements. The following detailed description is merely exemplary in nature and is not intended to limit the invention or the application and uses of the invention.

Various embodiments of the present invention provide input devices and methods that facilitate improved usability.

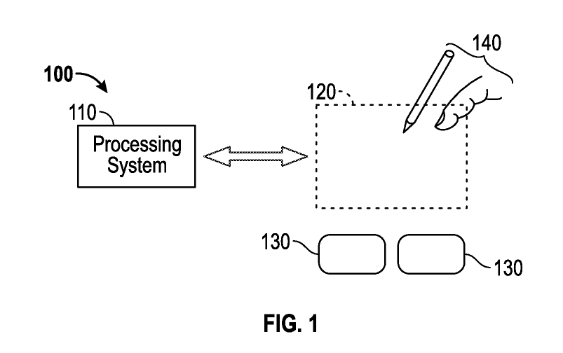

In FIG. 1, the input device 100 is shown as a proximity sensor device (also often referred to as a “touchpad” or a “touch sensor device”) configured to sense input provided by one or more input objects 140 in a sensing region 120. Example input objects include fingers and styli, as shown in FIG. 1.

Sensing region 120 encompasses any space above, around, in and/or near the input device 100 in which the input device 100 is able to detect user input (e.g., user input provided by one or more input objects 140). The sizes, shapes, and locations of particular sensing regions may vary widely from embodiment to embodiment. In some embodiments, the sensing region 120 extends from a surface of the input device 100 in one or more directions into space until signal-to-noise ratios prevent sufficiently accurate object detection. The distance to which this sensing region 120 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g., a touch surface) of the input device 100, contact with an input surface of the input device 100 coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region 120 has a rectangular shape when projected onto an input surface of the input device 100.

The input device 100 may utilize any combination of sensor components and sensing technologies to detect user input in the sensing region 120. The input device 100 comprises one or more sensing elements for detecting user input. As several non-limiting examples, the input device 100 may use capacitive, elastive, resistive, inductive, magnetic, acoustic, ultrasonic and/or optical techniques.

Some implementations are configured to provide images that span one, two, three, or higher dimensional spaces. Some implementations are configured to provide projections of input along particular axes or planes.

In some resistive implementations of the input device 100, a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device 100, one or more sensing elements pick up loop currents induced by a resonating coil or pair of coils. Some combination of the magnitude, phase, and frequency of the currents may be used to determine positional information.

In some capacitive implementations of the input device 100, voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g., system ground), and by detecting the capacitive coupling between the sensor electrodes and input objects.

Some capacitive implementations utilize “mutual capacitance” (or “transcapacitance”) sensing methods based on changes in the capacitive coupling between sensor electrodes. In various embodiments, an input object near the sensor electrodes alters the electric field between the sensor electrodes, thus changing the measured capacitive coupling. In one implementation, a transcapacitive sensing method operates by detecting the capacitive coupling between one or more transmitter sensor electrodes (also “transmitter electrodes” or “transmitters”) and one or more receiver sensor electrodes (also “receiver electrodes” or “receivers”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. A resulting signal may comprise effect(s) corresponding to one or more transmitter signals, and/or to one or more sources of environmental interference (e.g., other electromagnetic signals). Sensor electrodes may be dedicated transmitters or receivers, or may be configured to both transmit and receive.

In FIG. 1, a processing system 110 is shown as part of the input device 100. The processing system 110 is configured to operate the hardware of the input device 100 to detect input in the sensing region 120. The processing system 110 comprises parts of or all of one or more integrated circuits (ICs) and/or other circuitry components. For example, a processing system for a mutual capacitance sensor device may comprise transmitter circuitry configured to transmit signals with transmitter sensor electrodes, and/or receiver circuitry configured to receive signals with receiver sensor electrodes). In some embodiments, the processing system 110 also comprises electronically-readable instructions, such as firmware code, software code, and/or the like. In some embodiments, components composing the processing system 110 are located together, such as near sensing element(s) of the input device 100. In other embodiments, components of processing system 110 are physically separate with one or more components close to sensing element(s) of input device 100, and one or more components elsewhere. For example, the input device 100 may be a peripheral coupled to a desktop computer, and the processing system 110 may comprise software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes.

In some embodiments, the processing system 110 responds to user input (or lack of user input) in the sensing region 120 directly by causing one or more actions. Example actions include changing operation modes, as well as graphical user interface (GUI) actions such as cursor movement, selection, menu navigation, and other functions. In some embodiments, the processing system 110 provides information about the input (or lack of input) to some part of the electronic system (e.g., to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions.

For example, in some embodiments, the processing system 110 operates the sensing element(s) of the input device 100 to produce electrical signals indicative of input (or lack of input) in the sensing region 120. The processing system 110 may perform any appropriate amount of processing on the electrical signals in producing the information provided to the electronic system. For example, the processing system 110 may digitize analog electrical signals obtained from the sensor electrodes. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

Some embodiments include buttons 130 that may be used to select or activate certain functions of the processing system 110. In some embodiments, the buttons 130 represent the functions provided by a left or right mouse click as is conventionally known.

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media readable by the processing system 110). Additionally, the embodiments of the present invention apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

A “multi-function key” is used herein to indicate keys are capable of detecting and distinguishing between two types, three types, or more types of input or user interaction with the multi-function key. Some multi-function keys are capable of sensing multiple levels of key depression, key depression force, location of a touch or gesture on the key surface, etc. Some multi-function keys are capable of sensing and distinguishing between non-press touch or gesture on a key and a press on the key or a press/release interaction.

Multi-function keys having a touch sensitive portion may be configured with sensor systems using any appropriate technology, including any one or combination of technologies described in this detailed description section or by the references noted in the background section. As a specific example, in some embodiments, a sensor system for a spacebar comprises a capacitive sensing system capable of detecting touch on the spacebar and presses of the spacebar. As another specific example, in some embodiments, a sensor system for a spacebar comprises a capacitive sensing system capable of detecting touch on the spacebar and a resistive membrane switch system capable of detecting presses of the spacebar. Alternately, a touch sensitive area could be located on a bezel of a keyboard adjacent to the spacebar key. In those embodiments having a touchpad located adjacent to the spacebar, the touchpad could be used as a menu navigating touch surface. Generally, for improved ergonomics, some embodiments are configured to facilitate menu navigation and menu option selection without requiring a user's hands to leave the typing ready position.

Multi-function keys can be used to enhance user interfaces, such as improving ergonomics, speeding up information entry, providing more intuitive operation, etc. For example, multi-function keys configured in keypads and keyboards that capable of detecting and distinguishing between non-press touch input and press input may enable both navigation of a menu and selection of menu options using a same key.

“Non-press touch input” is used herein to indicate input approximating a user contacting a key surface but not pressing the key surface sufficiently to cause press input. “Press input” is used herein to indicate a user pressing a key surface sufficiently to trigger the main entry function of the key (e.g., to trigger alphanumeric entry for alphanumeric keys). In some embodiments, the sensor system is configured to consider the following as non-press touch input: inputs that lightly touch but does not significantly press the key surface, those input that presses on the key surface slightly, or a combination of these.

Most of the examples below discuss enhanced input possible with multi-function spacebars. However, other embodiments may enable similar functions using other keys such as shift, control, alt, tab, enter, backspace, function, numeric, or any other appropriate key. Further, some keyboard or keypad embodiments may each comprise multiple multi-function keys.

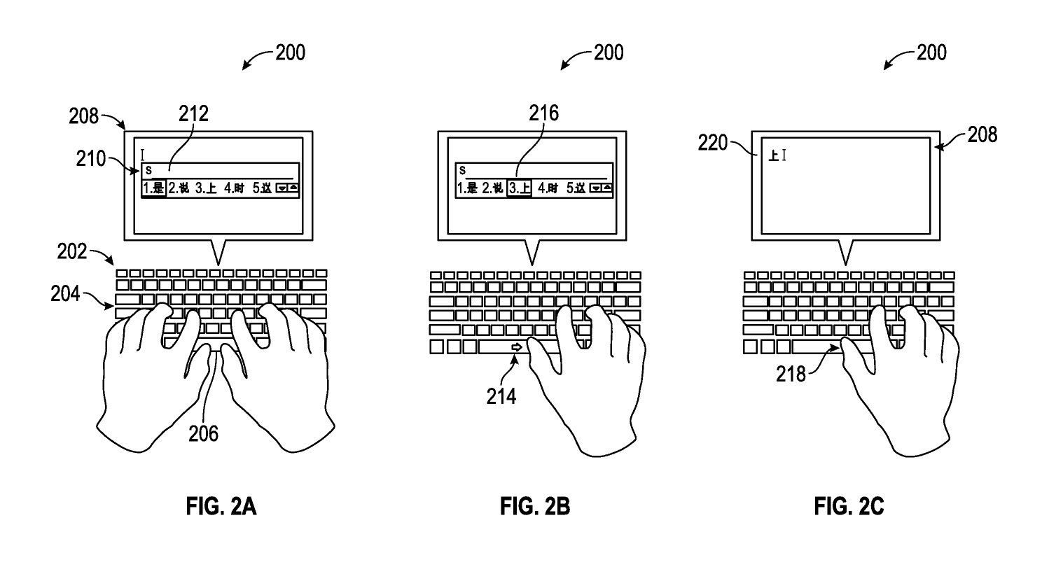

FIGS. 2A-C illustrate an example user navigation and input interface system 200 in accordance with various embodiments. The system 200 comprises a keyboard 202 having a plurality of keys 204 for a user to enter information (e.g., alphanumeric characters, punctuation, symbols or commands) by interacting with one or more of the plurality of keys 204. In this embodiment, the spacebar 206 is a multi-function key that is configured with a touch sensitive portion via a sensor system utilizing any appropriate technology. However, it will be appreciated that other keys such as shift, control, alt, tab, enter, backspace, function, numeric, or any other appropriate key may be implemented as the multi-function key. The spacebar touch sensitive portion is configured to detect non-press touch input on the spacebar surface (e.g., tap, double tap) and the motion of such non-press touch input along the spacebar (e.g., sliding gesture) in one dimension (1-D) along the width of the keyboard (left-and-right in FIG. 2B). The spacebar is also configured to detect press and/or release interactions with the spacebar by a user.

According to fundamental embodiments, as the user interacts with the plurality of keys 204, the processing system (110 in FIG. 1) presents on a display 208 a menu 210 of options for the user to select. Generally, the menu options presented are characters, words or phrases related to the user's interaction with the plurality of keys 204. The user navigates through the menu of options using the multi-function key (spacebar 206 in this example) via a touch or gesture interaction with the touch sensitive portion of the multi-function key. Thus, in FIG. 2A, the menu 210 is initially presented with the first option 212 highlighted (or otherwise indicated as being able to be selected). In FIG. 2B, the user interacts with the spacebar 206 (the multi-function key in this example) to enter a sliding gesture (indicated by arrow 214) and the menu selection moves along the menu (a one-dimensional (10D) menu in this example) to menu option 216. In FIG. 2C, when the user reaches the menu option desired to be selected, the user again interacts with the multi-function key (as indicated by 218) which causes the menu to be replaced by the selected menu options 220.

While FIGS. 2A-C illustrate an example for entering Chinese IME text input from a QWERTY keyboard it will be appreciated that any language (e.g., English, Japanese, French, Latin) may be more efficiently entered following the embodiments of the present invention. Additionally, various user interactions are contemplated for navigating and selecting menu options using the multi-function key. For example, menu navigation may be accomplished via one or more touch (tap) interactions. In embodiments having multiple pages of menu choices, some embodiments navigate between menu pages with a tap or double-tap input, and navigate within a menu page via a gesture interaction with the multi-function key. In some embodiments, a menu is navigated while the multi-function key is in an unpressed position and the menu item is selected via a press interaction with the multi-function key. The press interaction may be detected using any conventional technology such as a membrane switch or a capacitive touch sensor. In some embodiments, a menu is navigated while the multi-function key is in an pressed position and the menu item is selected via a release interaction with the multi-function key. That is, in some embodiments, a user may first press the multi-function key, and while the multi-function key is pressed, enter a sliding gesture to navigate through a presented menu and select a menu option via releasing the multi-function key.

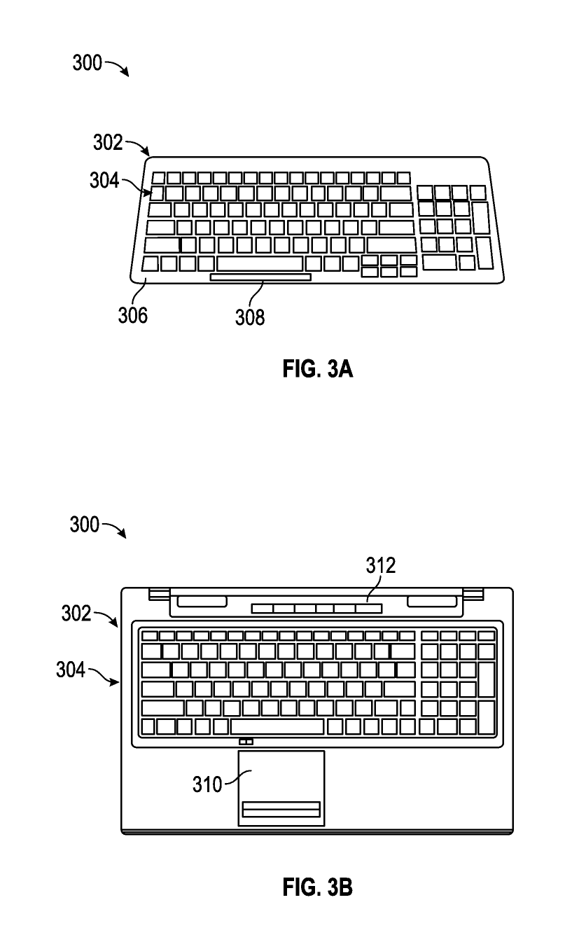

The general input sequence illustrated by FIGS. 2A-C may also be realized in various embodiments as shown in FIGS. 3A-B. In FIG. 3A, a navigation and input selection system 300 comprises a keyboard 302 having a plurality of keys 304 for a user to enter information by interacting with one or more of the plurality of keys 304. In this embodiment, the bezel 306 of the keyboard 302 includes a touch sensitive portion 308 via a sensor system utilizing any appropriate technology. Positioning the touch sensitive portion 308 adjacent to the spacebar offers an ergonomic advantage in that the user's hands need not leave the typing ready position to navigate through a menu presented by the processing system (110 in FIG. 1). After navigating to a particular menu option, the user may select the desired menu option via a touch, press or release interaction with a key (e.g., spacebar or one of the plurality of keys 304) causing the selected menu item the highlighted item to be displayed.

In FIG. 3B, a navigation and input selection system 300 comprises a keyboard 302 having a plurality of keys 304 for a user to enter information by interacting with one or more of the plurality of keys 304. In this embodiment, a conventional touchpad 310 is available for use in navigating a menu presented upon a user's interaction with one or more of the plurality of keys 304. Positioning the touchpad 310 adjacent to the spacebar offers an ergonomic advantage in that the user's hands need not leave the typing ready position to navigate through a menu presented by the processing system (110 in FIG. 1). After navigating to a particular menu option, the user may select the desired menu option via a touch, press or release interaction with a key (e.g., spacebar or one of the plurality of keys 304) causing the selected menu item the highlighted item to be displayed. Additionally, some embodiments may use a microphone 312 for receiving a voice command from a user that will display a menu for navigation and selection using the multi-function key.

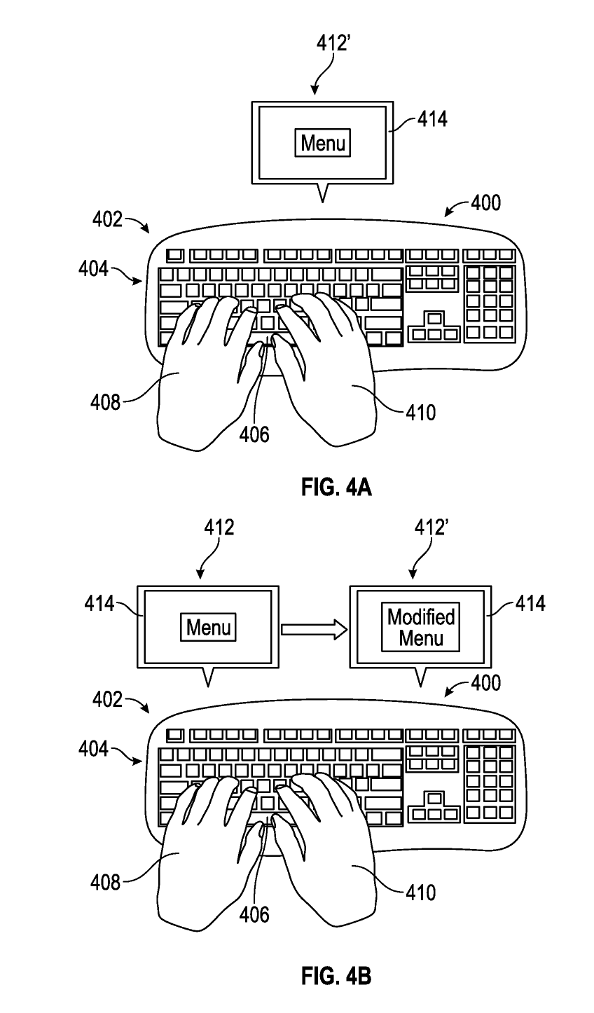

FIGS. 4A-B illustrate embodiments in which the touch sensitive portion of the multi-function key is configure to detect left and right hand touch or gestures (e.g., simultaneous multiple touch inputs). In FIG. 4A, a navigation and input selection system 400 comprises a keyboard 402 having a plurality of keys 404 for a user to enter information by interacting with one or more of the plurality of keys 404. In this embodiment, the multi-function key again comprises the spacebar 406 of the keyboard 302, although any other key of the plurality of keys 404 could be used to realize the multi-function key. By employing a larger aspect ratio key (e.g., spacebar, shift or enter) as the multi-function key, the touch sensitive portion of the multi-function key becomes large enough to facilitate a multi-touch interaction by a user's left hand 408 and right hand 410. In some embodiments, the processing system (110 in FIG. 1) only accepts user interaction with one hand (either left hand 408 or right hand 410). In some embodiments, the processing system (110 in FIG. 1) accepts user interaction with both hands (i.e., left hand 408 and right hand 410). For example, in some embodiments, after entering information with one or more of the plurality of keys 404 and having the menu 412 presented on a display 414, the user may navigate the menu 412 via interacting (e.g., touch or gesture) with the spacebar (in this example) 406 with the left hand 408 and enter menu option selection via a right hand 410 interaction (e.g., touch, press or release). Some embodiments respond only to a non-press touch interaction of the left hand 408 or the right hand 410 by responding to the first hand to move, or to the hand exhibiting greater motion.

Other embodiments contemplate additional advantages afforded by a multiple user interaction with the multi-function key. In FIG. 4B, the user may navigate the menu 412 via interacting (e.g., touch or gesture) with one hand (typically the dominate hand) and interact with the multi-function key with the other hand (typically the non-dominate hand) to modify the menu 412 presented on the display 414. As a non-limiting example, the left hand 408 could enter a touch or press interaction with the multi-function key (spacebar 406 in this example) to cause the menu 412 to become modified (menu 412′), and thereafter, navigate the modified menu 412′ via a right hand 410 interaction (e.g., touch or gesture). Option selection from the modified menu 412′ could then be entered with another right hand 410 interaction (e.g., touch, press or release). The menu 412 may be modified to menu 412′ in any manner desired for any particular implementation. Non-limiting examples of menu modification include, changing the menu size, menu language change, menu page tiling (that may be reduced in size if necessary to fit on the display 414) for multiple page menus, change the menu dimension (e.g., 1-D to 2-D, or vise-versa), magnification of the current menu option selection and change the menu options from icons to text (or vise-versa).

Still other embodiments contemplate further advantages afforded by a multiple user interaction with the multi-function key. For example, the user may navigate the menu 412 via interacting (e.g., touch or gesture) with one hand (typically the dominate hand) and interact with the multi-function key with the other hand (typically the non-dominate hand) to modify navigation of the menu 412 presented on the display 414. As a non-limiting example, the left hand 408 could enter a touch or press interaction with the multi-function key (spacebar 406 in this example) to modify how the menu 412 is navigated by the right hand 410 interaction (e.g., touch or gesture). Non-limiting examples of menu navigation modification include, changing the scrolling speed, changing from scrolling menu options to scrolling menu pages, change from vertical to horizontal menu navigation (or vise-versa). Still further, multiple user interactions with the multi-function key can combine the features of menu modification and menu navigation modification providing, for example, a combined menu scroll and menu zoom functions or a combined menu dimension change (e.g., 1-D to 2-D, or vise-versa) and menu navigation change from vertical to horizontal menu navigation (or vise-versa). Generally, any menu modification and/or navigation modification may be realized for any particular implementation.

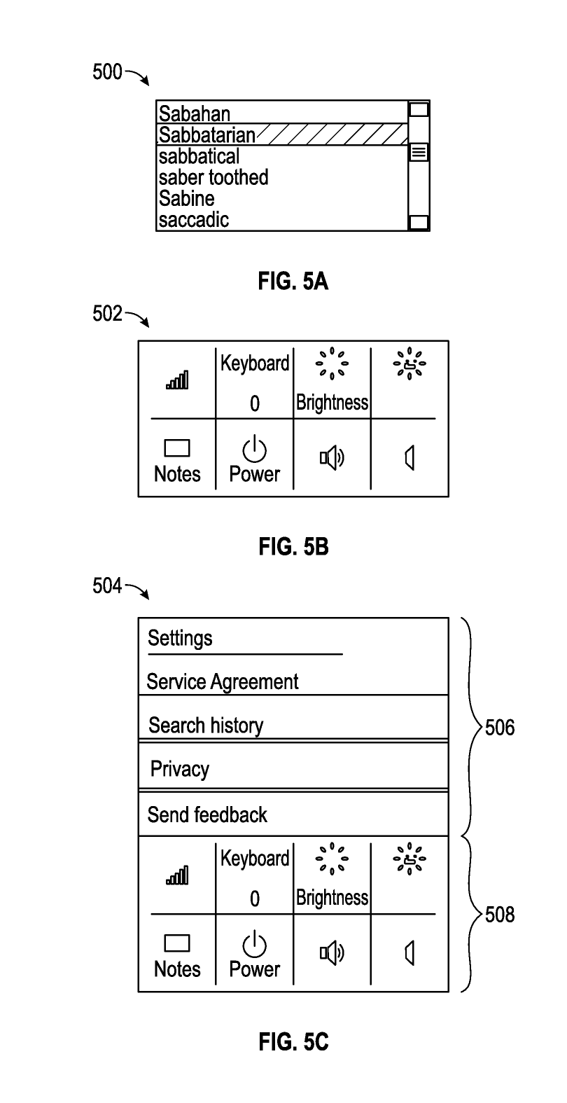

Many variations of the approach discussed above are possible. As one example of variations contemplated by the present disclosure, some embodiments use similar techniques to enable non-IME input. For example, some embodiments use similar techniques to enable vertical menu scrolling instead of the horizontal menu scrolling. FIG. 5A illustrates a menu 500 including a vertical 1-D menu for English input that may be realized using a QWERTY keyboard, in accordance with the embodiments described herein.

In FIG. 5B, a 2-D menu 502 is illustrated in accordance with an embodiment to navigating menu to select commands or a value adjustment. Example value adjustments include adjustment of brightness, volume, contrast, etc. In some embodiments, the 2D menu is navigated as if it was a 1-D menu laid out in separate rows or columns. That is, non-press touch interaction continued in one direction causes scrolling in a row (or column). In response to a user interaction that would travel past the end of the row, the active row (or column) changes to the next row (or column). In some embodiments, the 2D menu is navigated by 2D input on the multi-function (spacebar or other) key. That is, non-press user interaction along orthogonal axes within the touch sensitive portion causes orthogonal navigation (e.g., highlighter) motion in the menu.

FIG. 5C illustrates an example combination 1D-and-2D menu 504, in accordance with an embodiment. An upper part 506 of the menu 504 is a 1-D list, and a lower part 508 of the menu 504 is a 2×4 matrix. In some embodiments, this combined 1D-and-2D menu 504 is navigated as if it was a 1-D menu. Thus, non-press touch interaction continued in an associate direction (e.g., rightwards) causes scrolling down the 1D portion 506 until it reaches the 2D matrix 508. Continued non-press touch interaction in the same direction causes menu navigation into a row (or column) of the matrix portion 508. That is, in this embodiment, continued user interaction traveling past the end of the row, causes the active row (or column) to change to the next row (or column). In some embodiments, this combined 1D-and-2D menu 504 is scrolled as a combination menu, with 1D non-press touch interaction causing 1D scrolling in the list, and 2D non-press touch interaction causing 2D menu navigation in the matrix. In any particular embodiment, it will be appreciated that menus may be multi-dimensional and any menu dimension (or combinations thereof) may be used as desired to realize a presented menu to be navigated by a user.

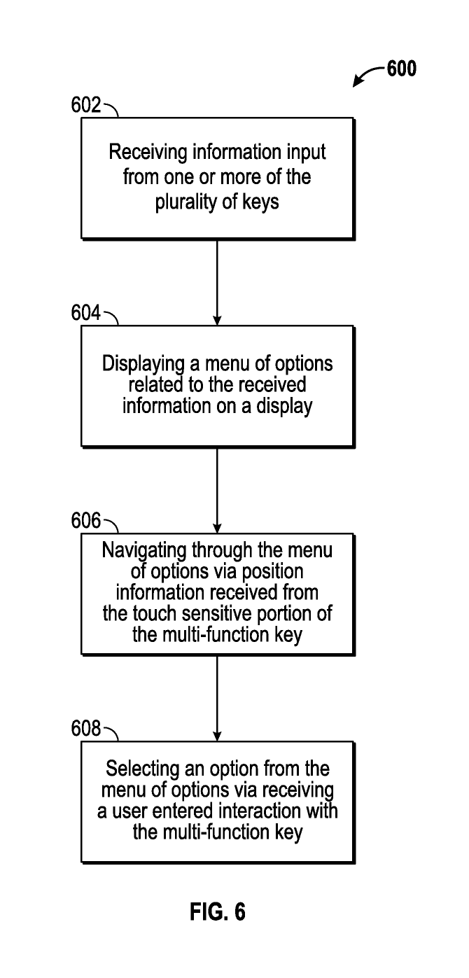

FIG. 6 is a flow diagram illustrating a method 600 in accordance with various embodiments. The method 600 begins in step 602 where a processing system (110 in FIG. 1) receives information input from one or more of the plurality of keys (204 in FIG. 2). Next, in step 604, a menu of options (210 in FIG. 2) related to the received information is presented on a display (208 in FIG. 2). The user navigates through the menu of options via position information received from the touch sensitive portion of the multi-function key (206 in FIG. 2). After navigating to a desired menu option, the user can select (step 608) the option from the menu of options via a user entered interaction with the multi-function key.

As a further examples of contemplated variations, in some embodiments comprise processing systems (110 in FIG. 1) that apply ballistics to the non-press touch interaction on the multi-function key (e.g., spacebar) to determine the amount of scrolling or value adjustment in response to the motion of the non-press touch. With ballistics, the speed, acceleration, or other characteristic of the motion of the non-press touch affects the output. In some embodiments, greater speeds, accelerations, or measure of other characteristic effectively applies a larger gain on the amount of motion to determine the amount of scrolling value adjustment.

Some embodiments also respond to certain non-press touch input differently. For example, a “flick” is a short-duration, single-direction, short-distance stroke where lift-off of the input object on the touch surface occurs while the input object is still exhibiting significant lateral motion. In some embodiments, a flick-type non-press touch input on the spacebar or another key causes faster scrolling or value adjustment, increases the discrete amounts associated with the scrolling or value adjustment (e.g., scrolling by pages instead of individual entries), causes continued scrolling or value adjustment after finger lift-off, a combination of these, etc. Some embodiments continue this scrolling or value adjustment at a constant rate until an event (e.g., typing on a keyboard, or touch-down of an input object on the key surface) changes the rate to zero. Some embodiments continue the scrolling or value adjustment at a rate that decreases to zero over time.

Some embodiments provide continued scrolling or value adjustment (“edge motion”) in response to non-press touch input being stationary on the space bar (or other key) surface if the non-press touch input immediately prior to being stationary fulfill particular criteria. For example, if the non-press touch interaction has traveled in a direction for a certain distance, exhibited certain speed or velocity or position histories, reached particular locations on the spacebar, or a combination of these, before becoming stationary, “edge motion” may occur. Such “edge motion” may continue until the input object providing the relevant non-press touch input lifts from the key surface, or until some other event signals an end to the “edge motion” intended.

In some embodiments, the multi-function key is configured to sense motion of the non-press touch input along the shorter dimension (as viewed from a top plan view) of the spacebar instead, or in addition to, non-press touch input along the longer dimension of the spacebar. In some of these embodiments, vertical scrolling occurs in response to this shorter-dimension motion.

In some embodiments, pressing the spacebar past a time period causes an applicable list to scroll at a defined given rate. In response to a release of the spacebar from the pressed position, selection of the then-highlighted item occurs.

In various embodiments, interaction with the spacebar is treated as relative motion (e.g., relative to an initial touchdown location on the spacebar) or with absolute mapping. In the case of absolute mapping, a processing system (110 in FIG. 1) coupled to the spacebar sensor system divides up the touch sensitive portion of the spacebar into regions that correspond with the different options on the selection menu. In some such embodiments, a five-item selection menu causes the spacebar to be divided into fifths. Touching one of the fifths highlights the item in the five-item menu corresponding with that fifth.

Other Multi-Function Key Applications

Multi-function keys have many other uses. Some examples include:

Overall presence detection (of a user near the keyboard). In some embodiments, in response to detecting the user's presence near the keyboard or hands over the keyboard, the system can cause a backlight to turn on or to wake up.

Accidental Contact Mitigation. In some embodiments, in response to fingers over the “F” and “J” keys (or some other keys) of the keyboard, the system does not respond to some or all of the input received on an associate touchpad near the keyboard.

Partial Key Press Detection. In some embodiments, the system can detect partial presses, and determines that a key has been pressed when the key depression is past a static or dynamic threshold. For example, some embodiments use 90% depression as a static “pressed” threshold. The system may be configured with hysteresis, such that a lower percentage of press (e.g., 85%) is associated with releasing the press.

Edge gestures. Some embodiments are configured to be able to detect non-press touch input over much or all of the keyboard. Some of these embodiments are configured to respond to input over the keyboard in the following way: a left-to-right swipe, top-to-bottom, right-to-left swipe, or bottom-to-top swipes each triggers a function. These functions may be the same or differ between these different types of swipes.

Thus, the embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

What is claimed is:

1. A system, comprising:
a keyboard comprising:
a plurality of keys for a user to enter information by interacting with one or more of the plurality of keys; and
a multi-function key having a touch sensitive portion for the user to enter position information by a touch or gesture input or enter information via user interaction with the multi-function key;
a processing system coupled to the keyboard for processing the user entered information and user entered position information from the keyboard; and
a display coupled to the processing system for displaying the user entered information and a menu of options related to the user entered information;
wherein, the user entered position information navigates through the menu of options and the user entered interaction with the multi-function key selects an option from the menu of options.

2. The system of claim 1, wherein user interaction on one or more of the plurality of keys causes the processing system to display the menu of options on the display.

3. The system of claim 1, wherein the user entered position information navigates through the menu of options while the multi-function key is in an unpressed position and the option is selected from the menu of options by a user entered press interaction with the multi-function key.

4. The system of claim 1, wherein the user position information navigates through the menu of options while the multi-function key is in a pressed position and the option is selected from the menu of options by a user entered release interaction with the multi-function key.

5. The system of claim 1, wherein the position information navigates through the menu of options and the option is selected from the menu of options by a user entered touch interaction with the touch sensitive portion of the multi-function key.

6. The system of claim 1, wherein the multi-function key comprises the spacebar of the keyboard and the user may enter the position information by a sliding gesture along the touch sensitive portion of the spacebar.

7. The system of claim 6, wherein the processing system is configured to determine left and right hand input from the user entered position information on the spacebar and accept input from only the left or right hand input.

8. The system of claim 6, wherein the processing system is configured to determine left and right hand input from the user entered position information on the spacebar and process both the left and right hand input to navigate through the menu of options.

9. The system of claim 6, wherein the processing system is configured process input from one of the left or right hands to display a modified menu and process input from the other of the left or right hands to navigate through the modified menu.

10. The system of claim 6, wherein the processing system is configured process input from one of the left or right hands to navigate through the modified menu and process input from the other of the left or right hands to modify menu navigation.

11. The system of claim 1, wherein the menu of options comprises words or phrases related to the user entered information from the plurality of keys.

12. The system of claim 1, wherein the menu of options comprises a one-dimensional menu and the user entered position information comprises one-dimensional position information for navigating the one-dimensional menu.

13. The system of claim 1, wherein the menu of options comprises a multi-dimensional menu and the user entered position information comprises one-dimensional position information for navigating the multi-dimensional menu.

14. The system of claim 1, wherein the user entered position information comprises two-dimensional position information for navigating the menu of options.

15. The system of claim 1, wherein the keyboard further comprises a microphone for receiving a voice command and the processing system displays a menu of options related to the voice command on the display for navigation via the user entered position information.

16. The system of claim 1, wherein the touch sensitive portion of the multi-function key comprises a capacitive touch sensor and user entered press or release interaction with the multi-function key is determined via a membrane switch associated with the multi-function key.

17. A method for entering information into a processing system from a keyboard having a plurality of keys and a multi-function key having a touch sensitive portion, the method comprising:
receiving information input from one or more of the plurality of keys;
displaying a menu of options related to the received information on a display;
navigating through the menu of options via position information received from the touch sensitive portion of the multi-function key; and
selecting an option from the menu of options via receiving a user entered interaction with the multi-function key.

18. The method of claim 17, wherein the position information navigates through the menu of options while the multi-function key is in an unpressed position and the option is selected from the menu of options by a user entered press interaction with the multi-function key.

19. The method of claim 17, wherein position information is received via a user entered sliding gesture along the touch sensitive portion of the multi-function key.

20. The method of claim 17, wherein the menu of options comprises words or phrases related to the information received from the plurality of keys.

21. The method of claim 17, further comprising receiving a voice command and displaying a menu of options related to the voice command for navigation via the received position information.

22. A keyboard for use with a processing system having a display, comprising:
a plurality of keys for a user to enter information by interacting with one or more of the plurality of keys; and
a multi-function key having a touch sensitive portion for the user to enter position information by a touch or gesture input or enter information via user interaction with the multi-function key;
wherein, when the keyboard is coupled to the processing system, the keyboard:
provides the user entered information for display;
provides the processing system with the user entered position information to navigate a displayed menu of options related to the user entered information; and
provides user entered interaction with the multi-function key for the processing system to select an option from the menu of options.
